(19) United States
(12) Patent Application Publication
(10) Pub. No.: US 2025/0165878 A1
(43) Pub. Date: May 22, 2025

(54) METHOD FOR OPTIMIZING PICKING MOVEMENT PATH

(71) Applicant: NSOFT Co., Ltd., Ulsan (KR)

(72) Inventors: Dae Hyoun CHOI, Ulsan (KR); Jae Gun YANG, Ulsan (KR); Sung Il PARK, Ulsan (KR)

(21) Appl. No.: 18/671,632

(22) Filed: May 22, 2024

(30) Foreign Application Priority Data
Nov. 21, 2023 (KR) 10-2023-0162388
Jan. 9, 2024 (KR) 10-2024-0003604

(51) Int. Cl. G06Q 10/047; G06Q 10/087

(52) U.S. Cl. CPC G06Q 10/047; G06Q 10/087

(57) ABSTRACT

One embodiment of a method for optimizing a picking movement path comprises the steps of collecting reference information on a product and worker who performs picking; processing the reference information; searching for a picking movement path of the product and the worker based on the collected processed reference information; selecting, by the worker, the searched picking movement path; and storing the reference information and the picking movement path selected by the worker in a business support system.

### CROSS-REFERENCE TO RELATED APPLICATIONS

This application claims the priority of Korean Patent Application No. 10-2023-0162388 filed on Nov. 21, 2023, and No. 10-2024-0003604 filed on Jan. 9, 2024, in the Korean Intellectual Property Office, the disclosures of which are incorporated herein by reference.

### STATEMENT REGARDING PRIOR DISCLOSURES BY THE INVENTORS

The inventor(s) of the present application are the author(s) of the articles, “A Study on Product Move Operation Optimal Path Based on Business Supporting System & Spatial Information” published on July 2023, “Implement Business Knowledge Formalization and Succession Structure by Applying Learning Pathfinding Algorithm Based on Data from The Backbone System” published on July 2023, and “Research on picking route optimization using an AI framework” published on November 2023, one year or less before the effective filing date of the present application, which are not prior art under 35 U.S.C. 102 (b)(1)(A).

### TECHNICAL FIELD

The present invention relates to a method, and more particularly to a method for optimizing a picking movement path.

### BACKGROUND OF THE INVENTION

Most product movement tasks are labor-dependent, and in particular, an order picking task is a process of taking out and shipping items stored in a logistics warehouse based on order information received from customers, and accounts for a very large portion of the warehouse tasks. The order picking task is the most labor-intensive among all warehouse functions and is so important that it accounts for half of the warehouse operating costs.

While skilled workers can perform their works by easily calculating order picking movement paths through the accumulation of experiential knowledge, unskilled workers lack the experiential knowledge to collect and organize the information necessary for work performance, including product location information and picking movement path. Further, there is a problem in small and medium-sized enterprises that it is difficult to a share work knowledge among workers due to the aging of average age of workers, the absence of new personnel and the disconnection in succession of empirical knowledge.

### SUMMARY OF THE INVENTION

The technical task to be achieved by the present invention is to provide a picking movement path optimization method that calculates an optimized picking movement path for products and workers by applying a path search algorithm and provides work picking movement path information extracted from the skilled workers to new workers.

The technical task to be achieved by the present invention is not limited to the task mentioned above, and other technical tasks not mentioned will be clearly understood by those skilled in the art from the description below.

In order to achieve the above technical task, a method for optimizing a picking movement path according to an embodiment of the present invention may comprise the steps of collecting reference information on a product and a worker who performs picking, processing the reference information, searching for a picking movement path of the product and the worker based on the collected processed reference information, selecting, by the worker, the searched picking movement path, and storing the reference information and the picking movement path selected by the worker in a business support system.

In an embodiment of the present invention, the reference information may include at least one of product warehousing information, product ordering information, location information of the product and the worker, and spatial information about the work site.

In an embodiment of the present invention, the product warehousing information and the product ordering information may be information about the warehousing and ordering number, the product number, warehousing time, etc., and the location information of the product and the worker may be information about the current location and the location to move.

In an embodiment of the present invention, the spatial information may be formed by processing the work location into a grid unit graph.

In an embodiment of the present invention, the step of processing the reference information includes forming an obstacle area, which is an area where the product and the worker cannot physically access, on the grid unit graph, and forming a path area that is an area where the product and the worker can move.

In an embodiment of the present invention, the step of searching for the picking movement path may include using a path search algorithm.

In an embodiment of the present invention, the path search algorithm may include searching a path where the sum of weights when moving from one point to another point on the grid unit graph becomes the minimum value.

In an embodiment of the present invention, the weight may be at least one weight suitable for the purpose of the picking movement path such as minimum cost, minimum distance, heuristic order, and negative weight.

In an embodiment of the present invention, the path search algorithm may be an algorithm suitable for a situation by considering at least one of the distance between vertices, constraints for picking equipment and situations occurring at the work site.

In an embodiment of the present invention, the step of storing the picking movement path may include converting the picking movement path into a database and storing it in the business support system in a time series manner.

### Effects of the Invention

The picking movement path optimization method according to embodiments of the present invention calculates the optimized picking movement path of the product and worker by applying a plurality of algorithms to optimize the picking movement path of the product and worker thereby expecting to reduce manpower costs.

Also, the picking movement path optimization method according to embodiments of the present invention extracts accumulated information about the work picking movement path from a skilled worker and provides the work picking movement path information extracted from the skilled worker to a new worker who is first deployed to the work site so that the worker can perform his/her work with the optimal picking movement path, thereby achieving optimal cost and optimal production.

It should be understood that the effects of the present invention are not limited to the effects described above and encompass all effects that can be inferred from the configuration of the invention described in the description or claims of the present invention.

### BRIEF DESCRIPTION OF THE DRAWINGS

The above and other preferred embodiments of the present invention will become more apparent from the following description with reference to the accompanying drawings.

FIG. 1 is a flowchart showing a picking movement path optimization method according to an embodiment of the present invention.

FIG. 2 shows a graph processed in a grid unit according to an embodiment of the present invention.

FIG. 3 shows a graph indicating an obstacle area on a graph processed in a grid unit according to an embodiment of the present invention.

FIG. 4 shows a graph indicating a path area on a graph processed in a grid unit according to an embodiment of the present invention.

FIG. 5 shows a graph indicating both an obstacle area and a path area according to an embodiment of the present invention.

FIG. 6 shows a graph composed of numbers to which the ACO algorithm is applied according to an embodiment of the present invention.

FIG. 7 shows a graph composed of numbers to which the ACO algorithm is applied according to another embodiment of the present invention.

FIG. 8 shows a graph indicating an unskilled worker's picking movement path on a graph processed in a grid unit according to an embodiment of the present invention.

FIG. 9 shows a graph indicating a skilled worker's picking movement path on a graph processed in a grid unit according to an embodiment of the present invention.

### DETAILED DESCRIPTION OF THE INVENTION

Hereinafter, the present invention will be described with reference to the attached drawings. However, the present invention may be implemented in various different forms and, therefore, is not limited to the embodiments described herein. In order to clearly explain the present invention in the drawings, parts unrelated to the description are omitted, and similar parts are given similar reference numerals throughout the specification.

Throughout the specification, when a part is said to be “connected (coupled, contacted, combined)” with another part, this includes the cases where it is not only “directly connected” but also “indirectly connected” with another member therebetween. Further, when a part is said to “include” a certain component, this means that other components are not excluded, but that other components can be added, unless specifically stated to the contrary.

The terms used in this specification are merely used to describe specific embodiments and are not intended to limit the invention. Singular expressions include plural expressions unless the context clearly states otherwise. It should be understood that terms such as “comprise” or “have” in this specification are intended to designate the presence of features, numbers, steps, operations, components, parts, or combinations thereof described in the specification, but are not intended to exclude in advance the possibility of the existence or addition of elements, numbers, steps, operations, components, parts, or combinations thereof.

Hereinafter, embodiments of the present invention will be described in detail with reference to the attached drawings.

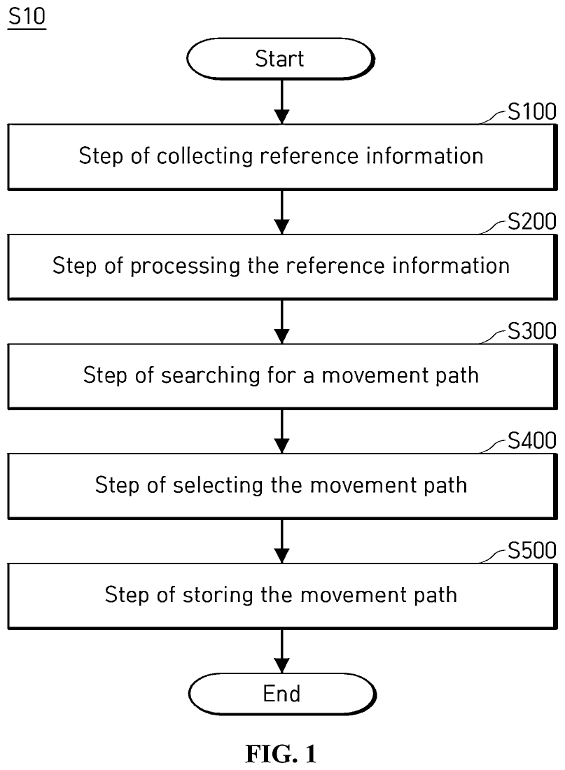

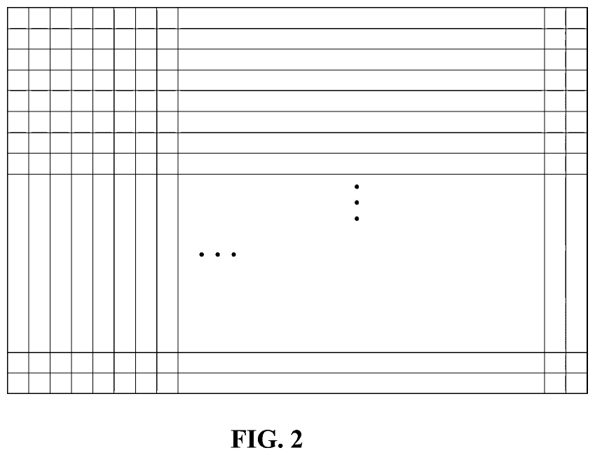

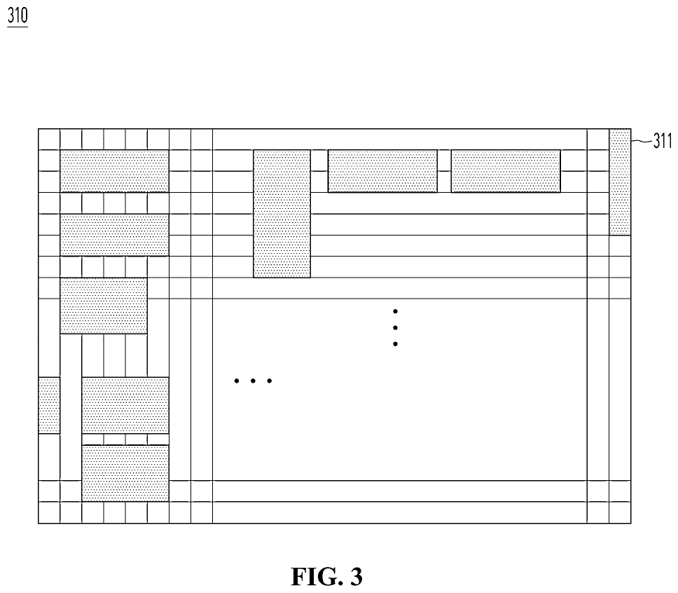

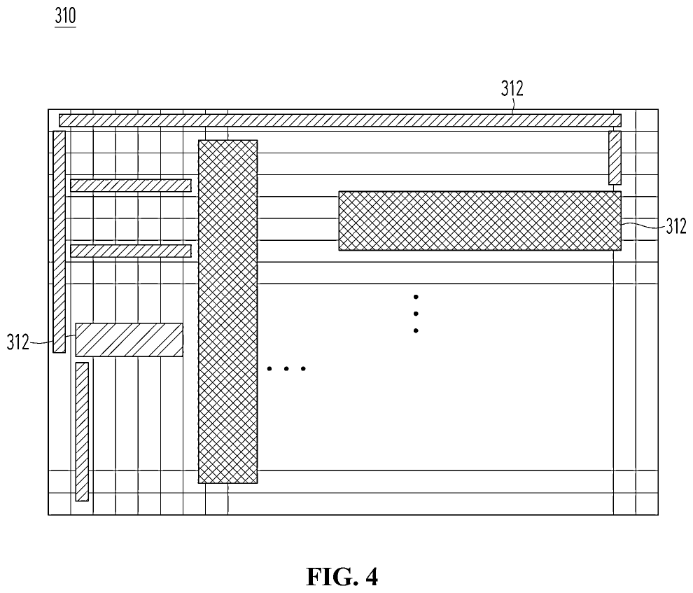

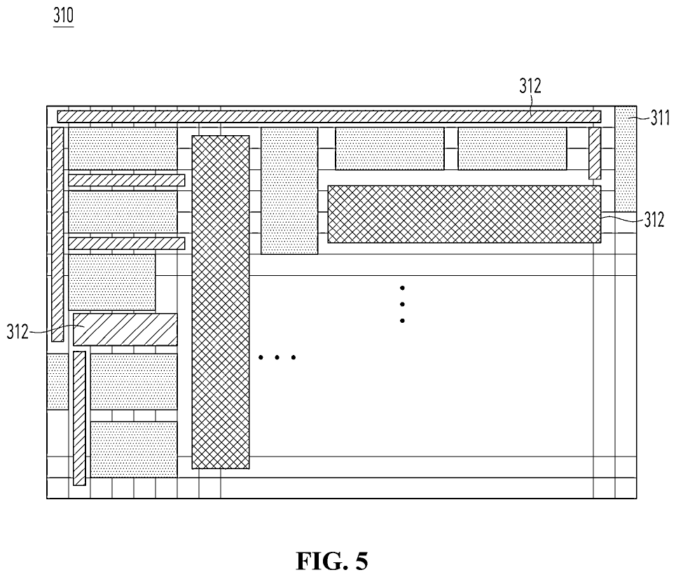

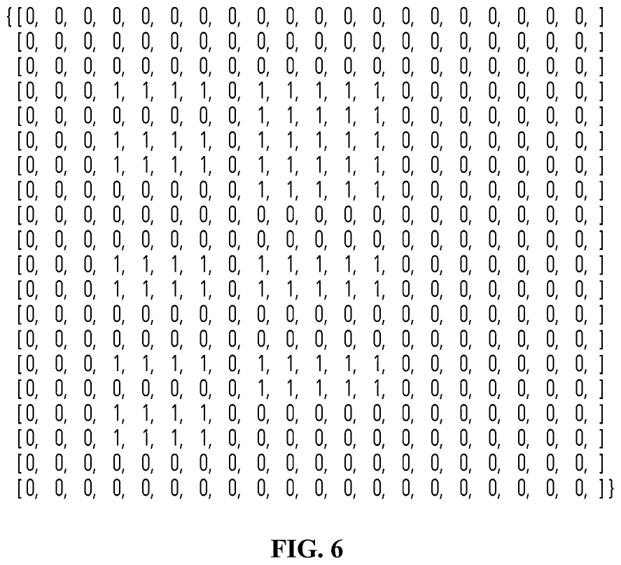

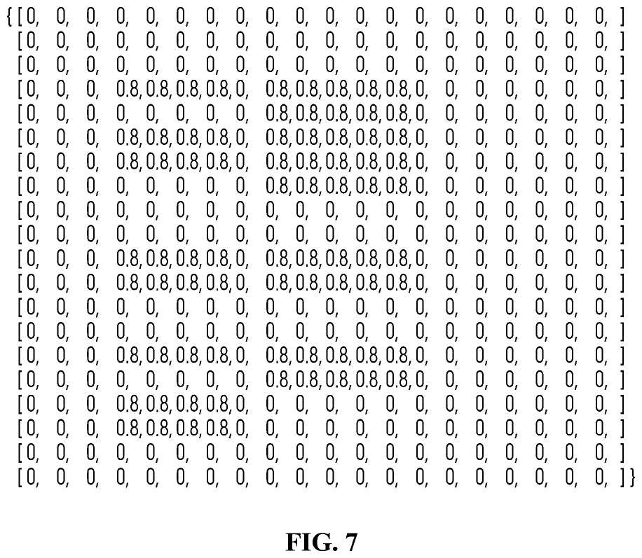

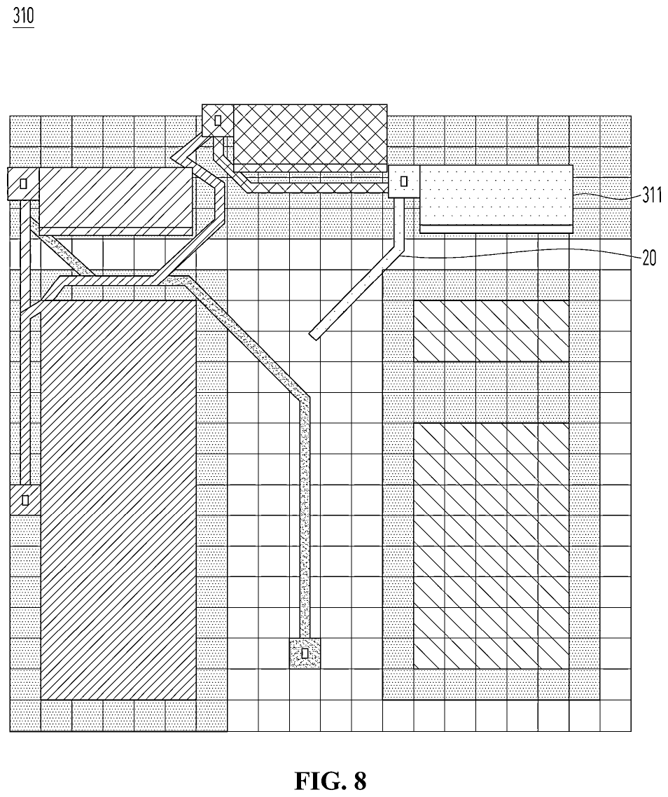

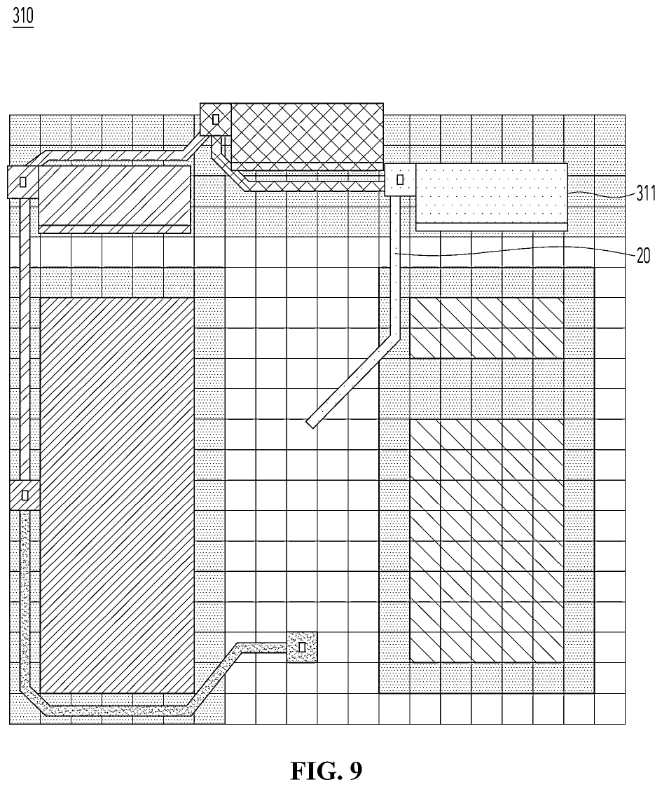

FIG. 1 is a flowchart showing a picking movement path optimization method according to an embodiment of the present invention. FIG. 2 shows a graph processed in a grid unit according to an embodiment of the present invention. FIG. 3 shows a graph indicating an obstacle area on a graph processed in a grid unit according to an embodiment of the present invention. FIG. 4 shows a graph indicating a path area on a graph processed in a grid unit according to an embodiment of the present invention. FIG. 5 shows a graph indicating both an obstacle area and a path area according to an embodiment of the present invention. FIG. 6 shows a graph composed of numbers to which the ACO algorithm is applied according to an embodiment of the present invention. FIG. 7 shows a graph composed of numbers to which the ACO algorithm is applied according to another embodiment of the present invention. FIG. 8 shows a graph indicating an unskilled worker's picking movement path on a graph processed in a grid unit according to an embodiment of the present invention. FIG. 9 shows a graph indicating a skilled worker's picking movement path on a graph processed in a grid unit according to an embodiment of the present invention.

Referring to FIGS. 1 to 9, the picking movement path optimization method (S10) according to an embodiment of the present invention may be a method for collecting and processing reference information to optimize the movement of the product (P) and the worker (W) who performs the picking. This may be a method of optimizing the picking movement path of the product (P) and the worker (W) performing the picking by utilizing a path search algorithm based on the collected and processed reference information. The picking movement path optimization method (S10) may be as follows.

The picking movement path optimization method (S10) may first collect reference information (S100). More specifically, in the reference information collection step (S100), the reference information, which is data stored in a business support system(S), may be collected. Here, the business support system 30 may use at least one of a manufacturing execution system (MES), an enterprise resource planning (ERP) and a warehouse management system (WMS). In one embodiment, the ERP and MES may be used simultaneously as the business support system 30. In another embodiment, the ERP and WMS may be used simultaneously. However, the present invention is not limited to thereto and only one or all of the MES, ERP and WMS may be used as the business support system 30.

The reference information 10 may be information including product information 100, location information 200 and spatial information 300 about the work location. More specifically, the reference information 10 may be information including product warehousing information 110, which is information about the warehousing number, product number, and warehousing time, product ordering information 120, which is information about the order number and product number, product location information 210, which is information about the current location of the product and location to move, worker's location information 220, which is information about the worker's current location and the location to move, and spatial information 300 which is information about the work site and work site conditions.

In performing the picking movement path optimization method (S10), the product warehousing information 110, the procedure for collecting the reference information 10 including product ordering information 120, product location information 210, worker location information 220, and spatial information 300 for the work site may be essential for creating the picking movement path 20.

Next, the reference information may be processed (S200). In the step (S200) of processing the reference information 10, first, the spatial information 300 about the work site may be processed (S210). At this time, the spatial information 300 may be formed by processing the entire sites into a graph 310 divided by a grid unit as shown in FIG. 2.

The grid unit graph 310 may be set differently depending on the size of the work site. In one embodiment, the grid unit may be set to 1 m, and in another embodiment, the grid unit may be set to 5 m. The present invention is not limited thereto, and in the case of a work site larger than the grid unit of 5 m, it goes without saying that the grid unit may be formed larger than 5 m.

After the spatial information is processed, an obstacle area, which is a physically inaccessible area, may be formed on the grid unit graph (S220). More specifically, an obstacle area 311 such as facility, equipment and structure that are physically inaccessible to the worker (W) may be formed on the graph 310 formed in the grid unit.

After the obstacle area is formed, a path area which is an area where the worker can move, may be formed on the grid unit graph, excluding the obstacle area (S230). The path area 312 may indicate a path and width over which the worker W can move. The path where the worker (W) can move may include a path where a transport equipment that transports products such as a forklift and a mobile rack rather than a person can move. As shown in FIG. 4, the path area 312 may be indicated differently on the graph 310 as a path through which worker (W) and transfer equipment can move and a path through which only the worker (W) can move.

Next, the picking movement path of the product and the worker may be searched based on the collected and processed reference information (S300). In the step of searching for the picking movement path 20 (S300), the picking movement path 20 may be searched using a path search algorithm. Here, the path search algorithm may search for a picking movement path 20 where the sum of weights becomes the minimum value when moving from one point to another point in the graph 310. Weights suitable for the purpose of the picking movement path may be used. More specifically, the picking movement path 20 may be searched by using at least one weight depending on the purpose of the picking movement path 20 among weights such as minimum cost, minimum distance, heuristic order, and negative weight.

As a path search algorithm, Dijkstra algorithm, a traveling salesman problem (TSP) algorithm, and an ant colony optimization (ACO) algorithm may be used. If there is no sufficient existing data for the picking movement path 20, the picking movement path 20 may be searched using the Dijkstra algorithm and the TSP algorithm. On the other hand, if there is sufficient existing data on the picking movement path 20 securing data according to increased usage of the business support system 30, the picking movement path 20 may be searched using the ACO algorithm.

Additionally, the path search algorithm may use an algorithm suitable for situation by considering the distance between vertices, constraints for picking equipment and the situations occurring at the work location. At this time, the distance between vertices may be the distance between a starting point and a destination point and in the case of picking a plurality of products (P), the distance may be the distance between one product (P) and another product (P). The constraints may be constraints for equipment used in the work area, such as forklift and mobile rack rather than a person. In addition, different algorithms may be used depending on situations of the work site such as when moving multiple products (P) and when moving a bulky product (P).

In one embodiment, when there is one picking target product (P), the Dijkstra algorithm may be used. The Dijkstra algorithm may be an algorithm that finds the shortest path from any one starting point to all other vertices. Therefore, when there is only one product (P) that the worker (W) needs to find, the picking movement path 20 can be searched by calculating only the shortest path to a single destination using the Dijkstra algorithm.

In another embodiment, when there are a plurality of picking target products (P), the TSP algorithm may be used. Here, the TSP algorithm may be an algorithm that finds a path with the minimum sum of weights among paths that pass from the starting point through all other vertices and return to the starting point when all vertices are connected and have weights. At this time, the TSP algorithm may reflect the condition that there are no restrictions on the picking order for products. Therefore, there are no restrictions on the picking order, and the optimal path to return to the starting point after picking all the plurality of picking target products (P) can be searched by the TSP algorithm.

When picking a plurality of picking target products (P), in another embodiment, the ACO algorithm may be used. The ACO algorithm may be one of the metaheuristic algorithms that solves optimization problems by imitating ant colony behavior. More specifically, the ACO algorithm may be an algorithm that solves an optimization problem by placing high pheromones on frequently traveled paths and applying the ants' tendency to select a path based on the amount of pheromone.

Here, the ACO algorithm can define a formula for optimizing the picking order of the worker (W) based on the reference information (10). Heuristic-based distance information, spatial information and empirical information can be used as variables used in the formula to optimize the picking order of the worker (W).

The formula for optimizing the picking order of the worker (W) can calculate the picking movement path 20 constituting the lowest cost by using the weight control variable (v) for each variable, distance-based heuristic score (H), spatial information-based score (S), knowledge information-based score (I), and cell activation score (C), and the formula for optimizing the picking order of the worker (W) can be Equation 1 below.

$$Min . Cost = H * {v}_{h} + {S}_{1} * {v}_{1} + … + {S}_{n} * {v}_{n} + I * {v}_{i} + C \qquad Equation 1$$

The heuristic-based distance information may be information on the remaining distance to the goal, and the spatial information may be additional information about the space where the worker is located. For example, the spatial information may be attribute information about whether a space has a specific purpose, such as whether it is a work space or whether it is a passageway. Additionally, the experiential information may be a variable that reflects the experiential information of the skilled worker (W1). The skilled worker (W1) can perform optimized work based on empirical facts, and the path that the skilled worker (W1) moves during work can be used in a formula to optimize the picking order of the worker (W). Variables such as total time required, total production volume, and work safety can be reflected in the formula to optimize the picking sequence of the worker (W) depending on the purpose.

The work picking movement path 20 can be reflected with the characteristics of the ACO algorithm and the improvement of optimal path according to changes in the reference information 10. For example, as shown in FIG. 6, the spatial information 300 about the work site can be formed as a graph composed of numbers, and when one task is completed, information about the picking movement path 20 used for the relevant task can be accumulated and stored. Thereafter, when a similar task is performed, the stored information about the picking movement path 20 can be used.

In addition, as shown in FIG. 7, in a graph where spatial information 300 is composed of numbers, information about the picking movement path 20 can play a role like a pheromone in the ACO algorithm, and as accumulation and volatilization for information about a single task are repeated and similar single operations are performed repeatedly, information about a specific path is accumulated numerically and only the finally accumulated information can be used for calculation.

The ACO algorithm can extract accumulated information about the work picking movement path (20) from the skilled worker (W1), and the work picking movement path information extracted from the skilled worker (W1) can be provided to the new worker (W2) who is first deployed to the work site.

The new worker (W2) can perform the picking task by selecting the work picking movement path as shown in FIG. 8. The new worker (W2) may choose an inefficient work picking movement path rather than an optimal path due to reasons such as sorting of the picking product lists by name and internal knowledge bias.

On the other hand, the ACO algorithm can optimize the work picking movement path and present it to the worker (W) as shown in FIG. 9. At this time, the ACO algorithm can suggest an optimized work picking movement path 20 by utilizing the reference information 10 stored in the business support system 30.

Therefore, the ACO algorithm can extract accumulated information about the work picking movement path 20 from the skilled worker (W1) and provide the extracted work picking movement path information to the new worker (W2) so that the worker (W) selects the picking movement path 20 based on the work picking movement path information, thereby achieving the optimal cost and optimal production for picking.

Next, the worker can select one of the plurality of searched picking movement paths (S400). In the picking movement path selection step (S400), the worker (W) may select the picking movement path 20 according to the purpose of the worker (W) among the plurality of picking movement paths 20 searched by the path search algorithm.

In one embodiment, the worker (W) can select the optimal picking movement path rather than the shortest picking movement path. For example, the worker (W) can select the shortest picking movement path in the picking order of product A, product B, and product C. However, since product B is the bulkiest and heaviest type and the worker (W) may prefer to firstly pick product B, which is the bulkiest and heaviest type, the worker (W) may select the picking movement path (20) in the order of product B, product A and product C. The present invention is not limited to thereto, and the worker (W) may select a picking movement path 20 that suits the purpose of the worker (W) rather than the shortest picking movement path.

Next, the reference information and the picking movement path selected by the worker may be stored in the business support system (S500). At this time, the business support system 30 may be provided with a storage unit 31.

The storage unit 31 may store the picking movement path 20 selected by the worker (W) among the picking movement paths 20 searched based on the path search algorithm. More specifically, the storage unit 31 may store a plurality of picking movement paths 20 searched according to purpose based on the path search algorithm.

The storage unit 31 may store the reference information and the plurality of searched picking movement paths 20 in a database. Accordingly, the storage unit 31 may include a reference information DB and a picking movement path DB. Also, the storage unit 31 may store the previously stored reference information 10 and the picking movement path 20 and the newly input reference information 10 and the picking movement path 20 in a time-series manner. At this time, the storage unit 31 may be, for example, a server that includes a memory capable of receiving and storing various types of data.

The picking movement path optimization method (S10) according to the embodiments of the present invention as described above applies a plurality of algorithms to optimize the picking movement path 20 of the product and worker and calculates the optimized picking movement path 20 of the product and worker, thereby expecting the effect of reducing manpower costs.

Also, the picking movement path optimization method (S10) according to the embodiments of the present invention as described above extracts accumulated information about the work picking movement path 20 from the skilled worker (W1), and extracts accumulated information about the work picking movement path 20 from the skilled worker (W1) and provides the new worker (W2) with work picking movement path information extracted from the experienced worker (W1), and thus the worker (W) can perform work using the optimal picking movement path (20) and achieve optimal cost and optimal production.

The description of the present invention described above is for illustrative purposes, and those skilled in the art will understand that the present invention can be easily modified into other specific forms without changing the technical idea or essential features of the present invention. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

What is claimed is:

1. A method for optimizing a picking movement path comprising the steps of:
collecting reference information on a product and worker who performs picking;
processing the reference information;
searching for a picking movement path of the product and the worker based on the collected processed reference information;
selecting, by the worker, the searched picking movement path; and
storing the reference information and the picking movement path selected by the worker in a business support system.

2. The method according to claim 1, wherein the reference information includes at least one of product warehousing information, product ordering information, location information of the product and the worker and spatial information about the work site.

3. The method according to claim 2, wherein the product warehousing information and the product ordering information are information about the warehousing and ordering number, the product number and warehousing time, etc., and the location information of the product and the worker is information about the current location and the location to move.

4. The method according to claim 2, wherein the spatial information is formed by processing the work location into a grid unit graph.

5. The method according to claim 1, wherein the step of processing the reference information includes forming an obstacle area, which is an area where the product and the worker cannot physically access, on the grid unit graph, and forming a path area that is an area where the product and the worker can move.

6. The method according to claim 1, wherein the step of searching for the picking movement path includes using a path search algorithm.

7. The method according to claim 6, wherein the path search algorithm includes searching a path where the sum of weights when moving from one point to another point on the grid unit graph becomes the minimum value.

8. The method according to claim 7, wherein the weight is at least one weight suitable for the purpose of the picking movement path such as minimum cost, minimum distance, heuristic order, and negative weight.

9. The method according to claim 6, wherein the path search algorithm is an algorithm suitable for a situation by considering at least one of the distance between vertices, constraints for picking equipment and situations occurring at the work location.

10. The method according to claim 1, wherein the step of storing the picking movement path includes converting the picking movement path into a database and storing it in the business support system in a time series manner.
